(19) United States
(12) Patent Application Publication
(10) Pub. No.: US 2008/0147635 A1
(43) Pub. Date: Jun. 19, 2008

(54) System, apparatus and method for providing weight to information gathering engine according to situation of user and computer readable medium processing the method

(76) Inventor: Il Im, Seoul (KR)

Correspondence Address: RABIN & Berdo, PC, 1101 14TH STREET, NW, SUITE 500, WASHINGTON, DC, 20005, US

(21) Appl. No.: 11/637,679

(22) Filed: Dec. 13, 2006

(51) Int. Cl. G06F 17/30

(52) U.S. Cl. 707/5; 707/E17.108

(57) ABSTRACT

This invention relates to a new system that integrates information from multiple information gathering engines (e.g. search engines or recommendation engines). The system calculates weights for the multiple information gathering engines based on user's given state or situation, updates the weights based on users' feedback, and applies them later when information from the multiple sources are merged.

### BACKGROUND OF THE INVENTION

1. Field of the Invention

This invention relates to a system that provides more accurate information to users by integrating information from multiple information gathering engines. More specifically, this invention relates to a system, an apparatus, and a method for providing weights to information gathering engines according to the situation of users, and a computer readable medium processing the method.

2. Description of the Related Art

Today's complicated computer and network environments make search and recommendation as necessary services for electronic commerce sites. Users usually search information from search engines, for example, Google, Yahoo and so on. FIG. 1 shows an example of search results using these search engines. Users get recommendation lists from an information gathering engine provided by websites such as Amazon and Yahoo! FIG. 2 shows an example of recommendation service in these websites.

As shown in FIG. 1, a user enters a keyword, for example, “deep impact,” in the keyword window 100 that he/she wants to search. The website then searches numerous pages in the Internet using its search engine(s) and provides the search results 110 to the user. If the website is utilizing multiple search engines, the results from multiple search engines are merged and sorted using a particular method. For example, the searched pages' relevance to the keywords or the posting date can be used when sorting the search results. Additional information about the searched results 120 could also be displayed. The sorting method is critical for the success of search engine because users evaluate search engines by the location of the relevant page in the search result.

As shown in FIG. 2, a user visits an online shopping site to search and purchase desired products. The website then generates personalized recommendations using its information gathering engine(s) and provides the recommendations 130 to the user. If the website is utilizing multiple information gathering engines, the results from multiple information gathering engines are sorted using a particular method. For example, the items' relevance to the user's interests or item price can be used when sorting the recommended items. Similar to search engines, the sorting method is critical for the success of information gathering engine.

Current Internet websites often use multiple information gathering engines together that adopt different technologies. There are numerous technologies for search and recommendation. Different information gathering engines may use one or more of these technologies. There are three dominant technologies for recommendation—collaborative filtering, content filtering, and association-rule based recommendations. Some hybrid information gathering engines adopt more than one of these technologies.

### SUMMARY OF THE INVENTION

It is an object of this invention to provide a system, an apparatus and a method for providing more accurate information to users by providing weights to information gathering engines such as search engines and recommendation engines according to the situation of a user, and a computer readable medium processing the method.

It is another object of this invention to provide a system, an apparatus, and a method for storing users' feedback about the information gathering engines and using it later for updating the weights for information gathering engines.

In order to achieve the above objects, according to an aspect, this invention provides a system for providing information from multiple information gathering engines such as search engines and recommendation engines, comprising a state application module which applies different weights to individual information gathering engines and updates the different weights based upon users' responses to recommendations.

According to another aspect, this invention provides an apparatus for providing information search of recommendation service upon users' requests using multiple search or recommendation engines, comprising: means that applies weights to the search or recommendation engines based upon current user's state data and other users' past state data stored in a state database; and means that updates weights for the search or recommendation engines based upon current user's feedback on search results or recommendation lists.

According to still another aspect, this invention provides a method for providing information search upon users' requests using multiple search engines, the method comprising the steps of: receiving users' search keywords and forwards the received search keywords to the search engines; receiving search results from the search engines and recognizing current user's state; searching for past state instances same as or similar to current user's state from a state database; extracting weights for the search engines from the past state instances found in the state database and applying the weights to the search engines based on the current user's state data along with the past state data stored in the state database to merge and re-sort the search results; and updating the weights for the search engines based on users' feedback on the search results.

According to still another aspect, this invention provides a method for providing recommendations upon users' requests using multiple recommendation engines, the method comprising the steps of: receiving users' requests and user information and forwarding the received users' requests and user information to the recommendation engines; receiving recommendations from the recommendation engines and recognizing current user's state; searching for past state instances same as or similar to the current user's state from a state database; extracting weights for the multiple recommendation engines from the past state instances found in the state database and applying the weights to the recommendation engines based on the current user's state data along with the past state data stored in the state database to merge and re-sort the recommendations; and updating the weights for the recommendation engines based on users' feedback on the recommendations.

The information to assign weights to information gathering engines can be stored in any media including ROM (read only memory), RAM (random access memory), CD (compact disk), DVD(digital video disk)-ROM, magnetic tape, floppy disk, optical storage, and carrier wave (Internet). The information and codes can also be stored and executed in distributed computers.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 shows keyword search in general search sites.

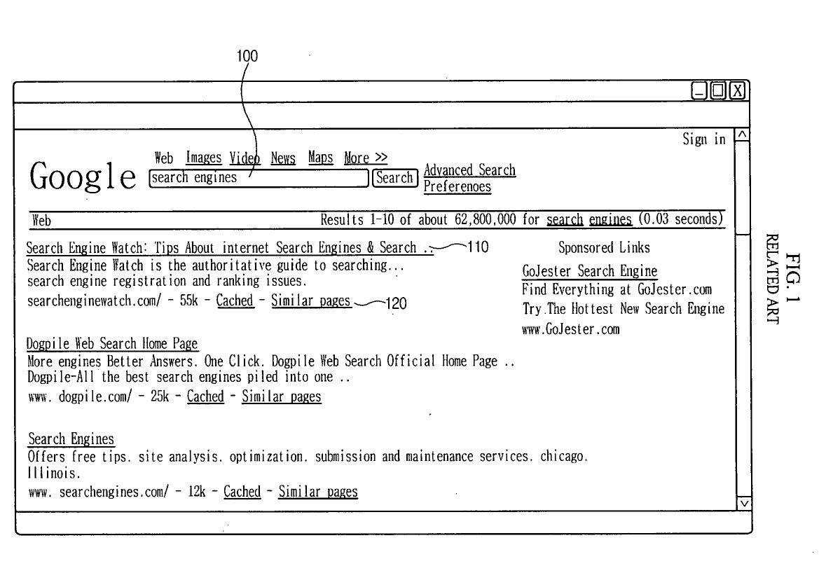

FIG. 2 shows recommendations in general web sites.

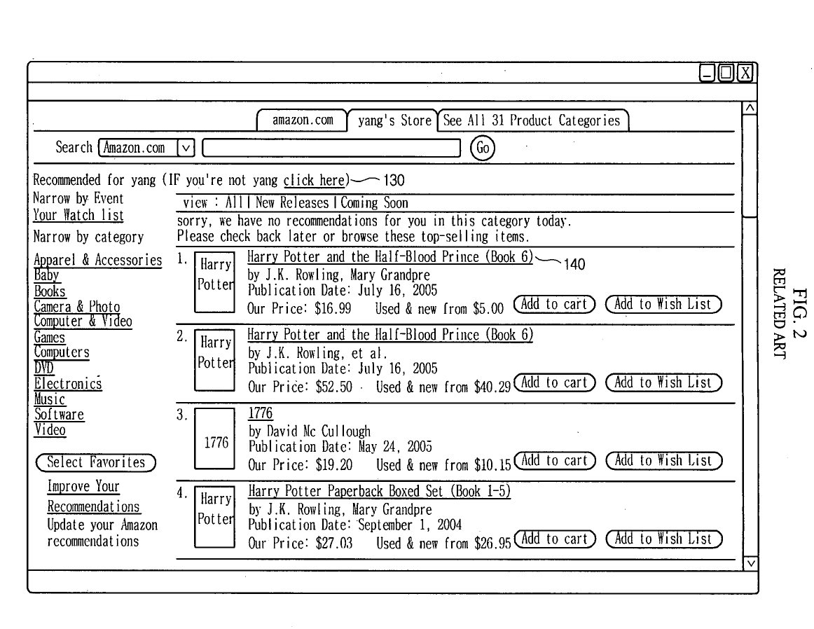

FIG. 3 shows a system that applies different user state-based weights to multiple search engines according to an embodiment of the invention.

FIG. 4 shows a detailed configuration of an apparatus that applies user state-based weights to multiple search engines according to an embodiment of the invention.

FIG. 5 shows a signal flow of a method for applying user state-based weights to multiple search engines according to an embodiment of the invention.

FIG. 6 shows a flow chart illustrating a process of applying state-based weights to the search results from multiple search engines according to an embodiment of the invention.

FIG. 7 shows a flow chart illustrating a process of finding records similar to current user's state from state database according to an embodiment of the invention.

FIG. 8 shows a flow chart illustrating a process of updating user state-based weights according to an embodiment of the invention.

FIG. 9 shows a system that applies different user state-based weights to multiple recommendation engines according to another embodiment of the invention.

FIG. 10 shows a detailed configuration of an apparatus that applies user state-based weights to multiple recommendation engines according to another embodiment.

FIG. 11 shows a signal flow of a method for applying user state-based weights to multiple recommendation engines according to another embodiment of the invention.

FIG. 12 shows a flow chart illustrating a process of applying state-based weights to the recommendations from multiple recommendation engines according to another embodiment of the invention.

FIG. 13 shows a flow chart illustrating a process of updating user state-based weights according to another embodiment of the invention.

### DETAILED DESCRIPTION OF THE PREFERRED EMBODIMENT

In this invention, users' feedback is used to determine how relevant the items in the information list are. Users' feedback can be explicit (users directly provide their feedback) or implicit (users' feedback is collected indirectly). This invention also proposes an effective way of collecting user feedback information.

When merged information list is shown to a user, an item is thought to be relevant if he/she selects it from the list and the information gathering engine that came up with it would be more relevant to the user in the given situation. Therefore, the data about what item came from what information gathering engine is stored and used to increase weights for information gathering engines whenever the user selects an item from the list. The stored weights are used later when information items for other users are integrated.

In the invention, more than one state variable that quantify the situation or circumstance of users are used. Even for a same user, the value of a state variable may vary depending on the situation of the user. Examples of state variable are as follows:

1. Site type—The type of site the user is currently visiting. e.g., portal site, online shopping mall, online news site, etc.

2. Field of search (category)—e.g., electronic products, education, inline skating, etc.

3. Time of the day—The time of the day the user is visiting the site

4. Day—Monday, Tuesday, etc.

5. Weather

6. Location or geographic region

7. User's current interest

8. Time spent for a page

These state variables would affect the type of needed information when users visit a site. For example, the information needs of a user searching information at noon would be different from that of a user searching information at 3:00 am. Thus, if these state variables are considered when search results or recommendations are integrated, more accurate information would be provided to the user.

In the system of this invention, it is recorded what item came from what information gathering engine before the integrated information list is sent to a user. When the user selects one item from the list, weight for the information gathering engine that provided the item is increased and weights for the information gathering engines that did not provide the item are decreased. The new weights are stored in the state database along with the current user's state variables. Therefore, the weights for information gathering engines are dynamically updated as users select items in the list provided.

When a user requests search or recommendation, the system forwards the request to individual information gathering engines and looks for same or similar states in the state database. If there is the same state, the system reads the weights for information gathering engines for the state record and uses them for integration of information from the information gathering engines. If there is no same state, it looks for most similar states and uses the weights in the same way. If there is no state record similar enough in the database, it concludes that the current user's state is new and applies equal weights to information gathering engines.

Hereinafter, more detail implementation examples of the invention is explained with reference to the accompanying drawings. Detail descriptions on certain parts are omitted if they may obstruct clear explanations of the main ideas of the invention.

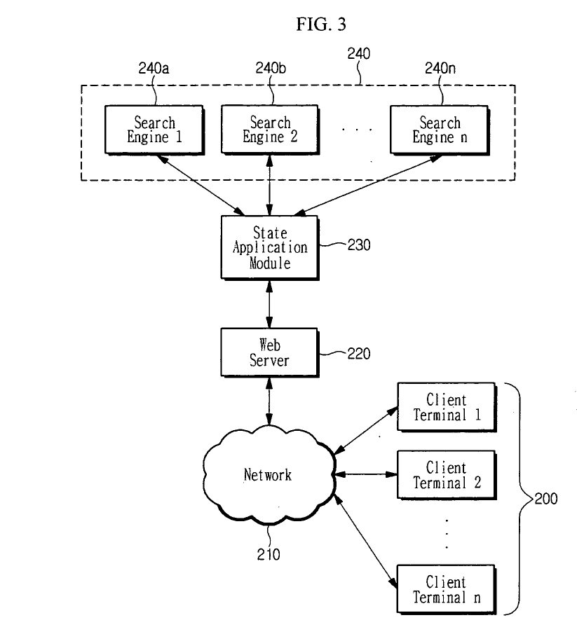

FIG. 3 shows a system that applies different user state-based weights to multiple search engines according to an embodiment of the invention. Referring to FIG. 3, the system includes client terminals 200, a network 210, a web server 220, a state application module 230, and search engines 240. Client terminals 200 are terminal devices with which a user visits web sites and receives search results. Network 210 is a wire/wireless network and it can be any type of network including LAN/WAN. Generally, the network is connected to the Internet.

A user accesses the webserver 220 through the network 210 from the client terminals 200. The webserver 220 can be a portal site such as Yahoo! or an information search site such as google.com that provides search services to users using its own search engines. Another form of implementation is linking the site to independent search engines that provide search results upon the request of the site.

The site sends search requests to multiple search engines 240. Search results from the search engines are merged into a final list using the weights calculated by the state application module 230. Users' state variables and their feedback are stored in the state application module 230 and used later when search results for other users are merged. The state application module 230 applies the stored weights to individual search engines and updates the weights using users' feedback.

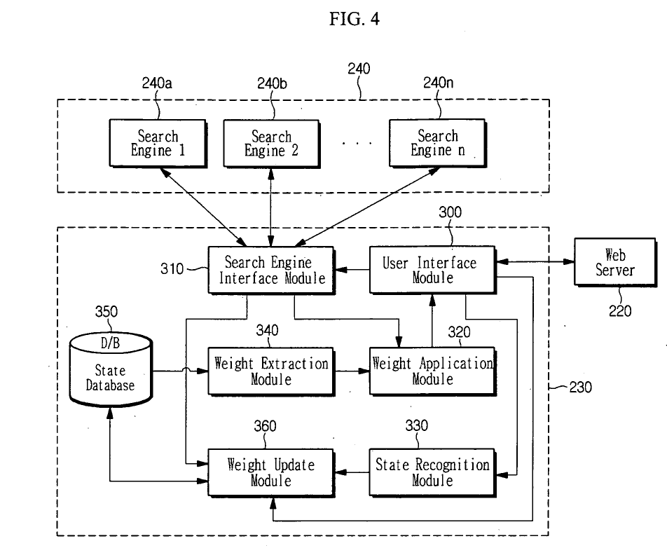

FIG. 4 depicts the state application module 230 in more detail. As shown in FIG. 4, the state application module 230 includes a user interface module 300, a search engine interface module 310, a weight application module 320, a state recognition module 330, a weight extraction module 340, a state database 350, and a weight update module 360. This system structure may be modified to other structures that provide identical functions. In FIG. 4, the thick lines represent the information flow for updating weights based upon users' feedback.

When a user requests information search, the process that applies weights for different search engines considering the state of the user in this invention is as follows. Search request from a user including keywords is sent to the user interface module 300 by the web server 220. The user interface module 300 has two main roles; a) receiving search requests from the web server 220 and forwarding them to the search engine interface module 310; b) receiving the integrated search results from the weight application module 320 and forwarding them to the web server 220.

The search engine interface module 310 receives search requests including keywords from the user interface module 300, forwards the search requests to multiple search engines 240, and receives search results from them. Search results from the search engines 240 are sent to the weight application module 320 and weights based on user's current state are applied.

The state recognition module 330 recognizes user's state variables when search request from the user is received. Suppose “time of the day”, “field of search,” and “user's current interest” are, for example, used as the state variables (Other information, of course, can be used in addition to these variables.). When a user's request is received by the user interface module 300, it notifies the request to state recognition module 330. Then, the state recognition module 330 extracts the time of the day, field of search, and user's current interest. The detail methods to extract the state information will be described later.

The state data extracted by the state recognition module 330 is used by the weight extraction module 340 to extract weights for similar states and by the weight update module 360 to update weights for current state.

The weight extraction module 340 looks up the past state data stored in the state database 350 to find state instance(s) same as or similar to the current user's state information provided by the state recognition module 330. Once same or similar state instances are found, the weights for search engines in those state instances are read and sent to the weight application module 320.

The weight application module 320 applies the weights from the weight extraction module 340 to search results from the search engine interface module 310 to merge and re-sort the results.

The merged search results are sent to the user interface module 300, forwarded to the web server 220, and sent to users at the client terminals 200. The user sees the results and responds by selecting one or more items in the search result. The user responses are sent to user interface module 300 through the web server 220. The user interface module 300 forwards these user responses to the weight update module 360 to update weights for individual search engines for the given state.

The weight update module 360 updates the weights in the state database 350 using the user's responses received from the user interface module 300. When weighs are updated, the weight update module 360 uses search results from the search engine interface module 310 and current user's state information from the state recognition module 330. Updated weights are stored in the state database 350 and used for future search. The detail methods for weight update is describe below.

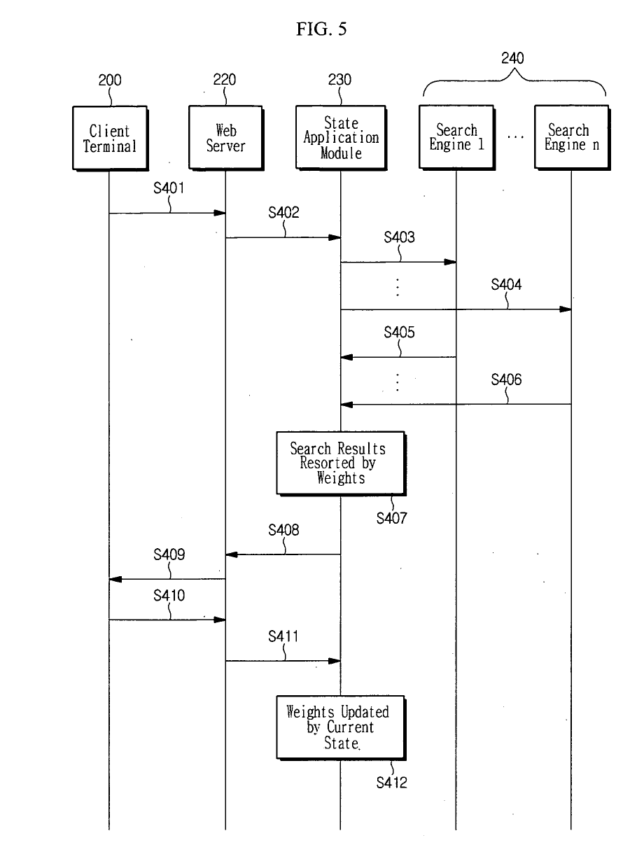

FIG. 5 depicts a flow of signals when weights for individual search engines are calculated. Referring to FIG. 5, a user connects to a portal site or search site using his/her client terminal 200 and types in search keywords. The search request and search keywords are sent (S401) to the web server 220 and the search request and keywords are forwarded (S402) to state application module 230.

The state application module 230 sends search requests (S403, S404) to multiple search engines 240. The search results from the search engines 240 are sent back (S405, S406) to the state application module 230.

The state application module 230, as described above, compares current user's state with past users' states to find weights for search engines in the same or similar states. The extracted weights for search engines are applied to search results from search engines to generate the merged/re-sorted final result (S407).

The final result is sent (S408) to the web server 220 and presented (S409) to the user at the client terminal 200. User responds to the search results by opening one or more items in the search result. User's response is sent (S410) to the web server 220 and forwarded (S411) to the state application module 230. The state application module 230 updates and stores weights for search engines (S412) based upon the user responses.

The detailed process that the state application module 230 applies weights to search engines according to the users' states is described below.

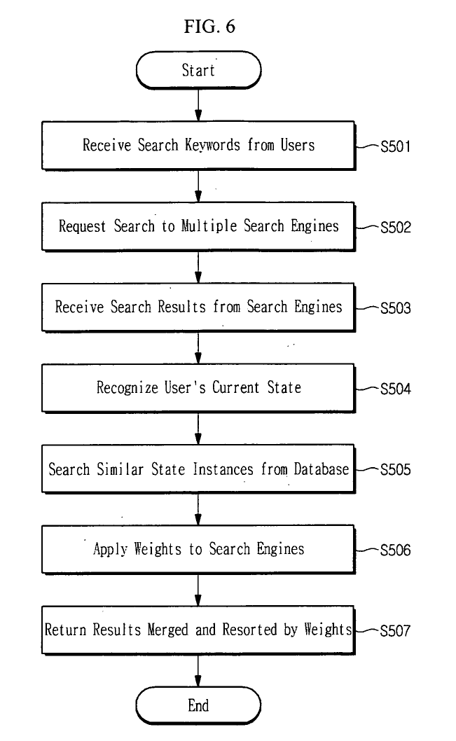

FIG. 6 shows a flow chart illustrating a process of applying state-based weights to the search results from multiple search engines according to an embodiment of the invention. As shown in the figure, the state application module 230 receives search keywords (S501) and requests search to multiple search engines with the keywords (S502).

The state application module 230 receives search results (S503) from the search engines and detects current user's state variables (S504). The state application module (230) then searches for state instances (S505) same as or similar to current user's state from the state database. It extracts weights for search engines for the same or similar state instances found and the extracted weights are applied to search results (S506). The search results are merged and re-sorted (S507) before sent to user's client terminal.

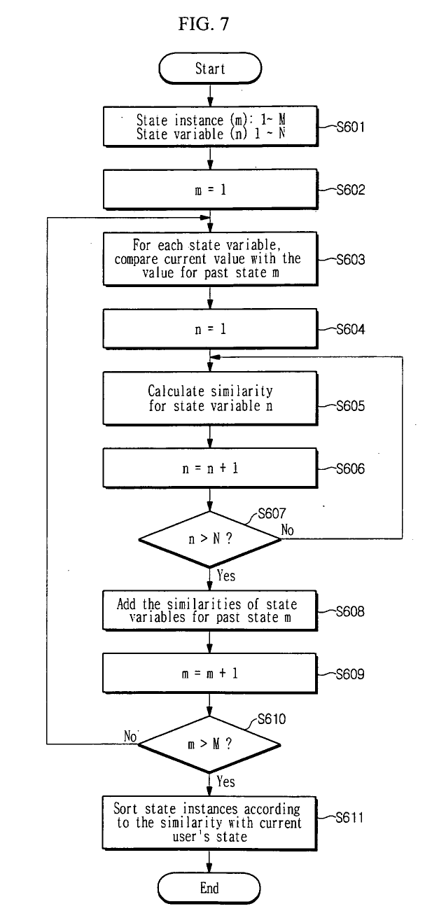

FIG. 7 is a flowchart that depicts the process to find same or similar state instances. As shown in the figure, suppose the number of past state instances stored in the state database 350 is M and the number of state variables is N (S601). Staring with the first state instance (m=1) stored in the database (S602), the values of current user's state variables are compared with the state instances (S603).

For state instance m, state variables of the instance are compared with those of current users. From n=1 to N, the value of state variable n is compared with the value of state variable of current user (S604)—the similarity of state variable n between current user and state instance m is calculated (S605). The detail examples of calculating similarities will be described later.

As n is increased (S606), similarity value for each state variable are calculated (S607). Once similarity values for all state variables for the given state instance m are calculated, the final similarity index for the state m is calculated (S608) by summing the similarities for all state variables.

Similarity indices for all state instances can be calculated by repeating the above process for m and then increasing m by 1 (S609) until m reaches to M (S610). Finally, the similarity indices are sorted (S611) and most similar states are identified.

In this invention, as addressed before, the weights for search engines for each state instance are updated based upon users' feedback to search results. This keeps the weights for search engines up-to-date and changes in users' preferences and needs are reflected in the weights.

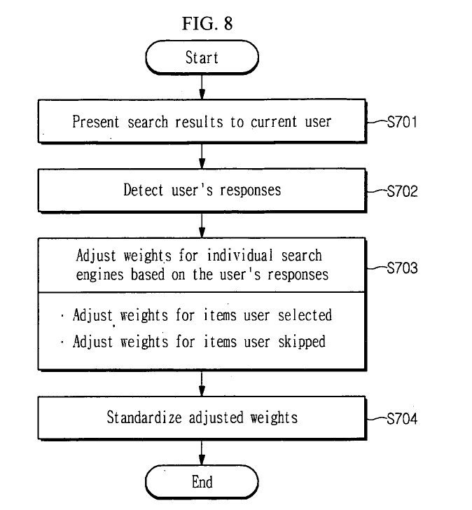

FIG. 8 shows a detail process of updating weights for search engines. As shown in the figure, the system of this invention presents search results to the user who requested the search (S701). The user then responds by clicking on or opening one or more items in the search result. These responses are sent to the state application module 230 and the state application module 230 detects the user's responses (S702).

The state application module 230 adjusts the weights for search engines based on the user's responses (S703). The adjustment can be one of the two kinds—adjustments for the items selected and adjustments for the items skipped. If a user selects an item from the list, this implies that the item is relevant to the user. Therefore, the weights for the search engines that brought the item are increased. On the other hand, if the user skips an item in the list, this implies that the item is not relevant to the user. Thus, the weights for the search engines that brought the item are decreased. Finally, the adjusted weights may need to be normalized such that their values fall between certain ranges (S704).

The system, equipments, and methods for this invention have been explained in detail with an application example of search engine. Another application example of this invention, recommendation system, will be described below.

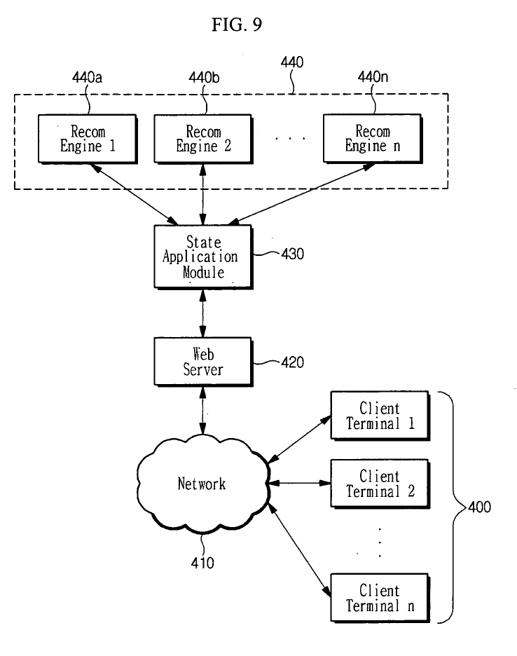

FIG. 9 is similar to FIG. 3 and depicts the system that applies different weights to different recommendation engines. As shown in FIG. 9, the system includes client terminals 400, a network 410, a web server 420, a state application module 430, and a recommendation engine 440. Client terminals 400 are devices with which a user visits web sites and receives recommendations. The network 410 is a wire/wireless network and it can be any type of network including LAN/WAN. Generally, the network is connected to the Internet.

A user accesses the webserver 420 through the network 410 at a client terminal 400. The webserver 420 can be a portal site such as Yahoo! or an online shopping site such as Amazon.com that provides recommendations to users using its own recommendation engines. Another form of implementation is linking the site to independent recommendation engines that provide recommendations based upon the request of the site.

In some cases, users explicitly request recommendations and in other cases, the site decides to provide recommendations without users' explicit requests. For the convenience of illustration, both cases are called ‘recommendation request’ in this invention.

The site sends recommendation requests to multiple recommendation engines 440. Recommendations from the recommendation engines are merged into a final list using the weights calculated by the state application module 430. Users' state data and their feedback are stored in the state application module 430 and used later when generating recommendations for other users. The state application module 430 applies the stored weights for individual recommendation engines and updates the weights based upon users' feedback.

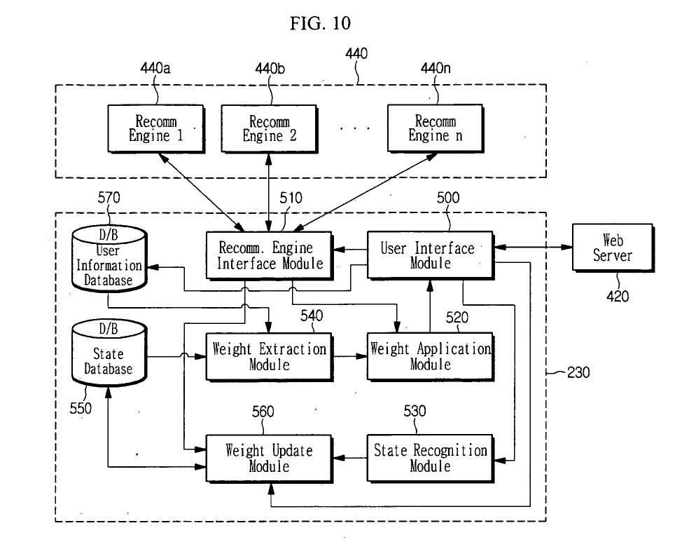

FIG. 10 depicts a detailed configuration of the state application module 430. As shown in FIG. 10, the state application module 430 includes a user interface module 500, a recommendation engine interface module 510, a weight application module 520, a state recognition module 530, a weight extraction module 540, a state database 550, a weight update module 560, and a user information database 570. This system structure may be modified as appropriate to provide identical functions. In FIG. 10, the thick lines represent the information flow to update weights according to users' feedback.

The process that applies weights to different recommendation engines considering the state of the user in this invention is as follows. The recommendation request may be initiated by user or the Web server 420. In both cases, the Web server 420 sends the recommendation request, along with user information, to the user interface module 500. The user interface module 500 has two main jobs; 1) receiving recommendation request from the web server 420 and forwarding them to the recommendation engine interface module 510 and receiving the integrated recommendations from the weight application module 520 and forwarding them to the web server 420.

The recommendation engine interface module 510 receives recommendation request including user information from the user interface module 500, forwards the recommendation request to multiple recommendation engines 440, and receives recommendations from them. If the user is logged in, the user's personal information such as past purchase history can be sent to the recommendation engines to generate more accurate recommendations. If the user is not logged in, only the user's current information is used to generate recommendations. Recommendations from the recommendation engines 440 are sent to the weight application module 520 and weights based on user state are applied.

The state recognition module 530 recognizes user's state data when recommendation request from the web server 420 is received. Suppose “time of the day”, “field of recommendation,” and “user's current interest” are, for example, used as state variables (Other information, of course, can be used in addition to these variables.). When a recommendation request is received by the user interface module 500, it notifies the request to the state recognition module 530. Then, the state recognition module 530 extracts the time of the day, field of recommendation, and user's current interest.

The state information extracted by the state recognition module 530 is used by the weight extraction module 540 to extract weights for similar states and the weight update module 560 to update weights for current state.

The weight extraction module 540 looks up the past state instances stored in the state database 550 to find state instance(s) same as or similar to the current user's state information provided by the state recognition module 530. Once same or similar state instances are found, the weights for recommendation engines in those states are read and sent to the weight application module 520.

The weight application module 520 applies the weights from the weight extraction module 540 to recommendations from the recommendation engine interface module 510 to merge and re-sort the results.

The merged recommendations are sent to the user interface module 500, forwarded to the web server 420, and sent to users at client terminals 400. The user sees the results and responds by selecting one or more items in the recommendation list. User responses are sent to the user interface module 500 through the web server 420. The user interface module 500 forwards these user responses to the weight update module 560 to update weights for recommendation engines for the given state.

The weight update module 560 updates the weights in the state database 550 based on the user responses received from the user interface module 500. When weighs are updated, the weight update module 560 uses recommendation from the recommendation engine interface module 510 and current user's state information from the state recognition module 530. Updated weights are stored in the state database 550 and used for future recommendation. The detail methods for weight update will be described later. Users' surfing behaviors (clickstreams) are also stored in the user information database 570 to be used for generating recommendations in the future.

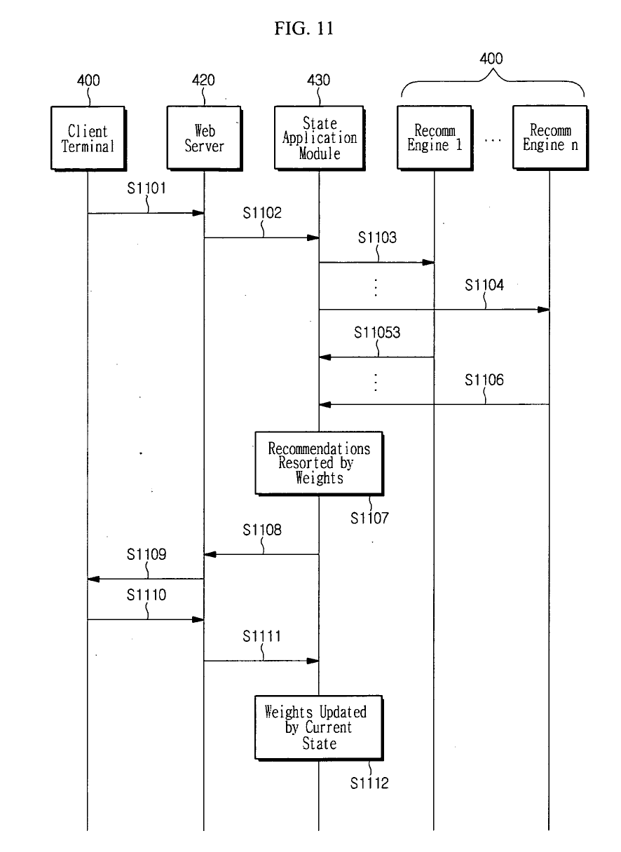

FIG. 11 depicts a flow of signals when weights for individual recommendation engines are calculated. As shown in FIG. 11, a user accesses a portal site or an online shopping site using his/her client terminal 400. The user requests recommendations (S1101) or the web server 420 initiates recommendation service and the recommendation request and user information are forwarded to state application module 430 (S1102).

The state application module 430 sends recommendation requests to multiple recommendation engines 440 (S1103, S1104). The recommendations from the recommendation engines 440 are sent back to the state application module 430 (S1105, S1106).

The state application module 430, as described above, compares current user's state with past users' states to find weights for recommendation engines. The extracted weights for recommendation engines are applied to recommendations from recommendation engines to generate the merged/re-sorted final result (S1107).

The final result is sent to the web server 420 (S1108) and presented to the user at the client terminal 400 (S1109). User responds to the recommendations by opening one or more items in the recommendation list. User's response is sent to the web server 420 (S1110) and forwarded to the state application module 430 (S1111). The state application module 430 updates and stores weights for recommendation engines (S1112) based upon the user responses.

The detail process that the state application module 430 applies weights to recommendation engines according to the users' states will be described below.

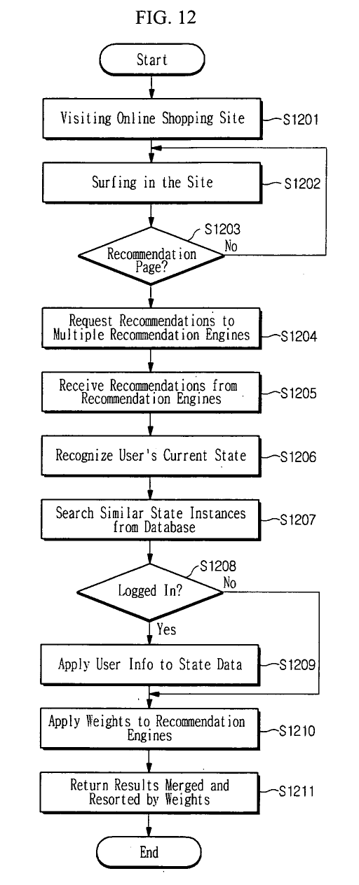

FIG. 12 shows a flow chart illustrating a process of applying state-based weights to the recommendations from multiple information gathering engines according to another embodiment of the invention. As shown in FIG. 12, a user visits a shopping site or a portal site S1201 and surfs the site (S1202). Here, the user may or may not be logged in to the site. Recommendations for both cases are illustrated below. When the user requests recommendation or visits a page that needs to display recommendations (S1203), the web server 420 sends recommendation request to the state application module 430 (S1204). The state application module 430 receives the recommendation request (S1203) and forwards this request to multiple recommendation engines with the user information (S1204).

The state application module 430 receives recommendations from the recommendation engines (S1205) and detects current user's state variables (S1206). The state application module 430 then searches for state instances same as or similar to the current user's state from the state database (S1207). If the user is logged in (S1208), the user information is used as additional state data (S1209). It extracts the weights for recommendation engines for these same or similar state instances found and the extracted weights are applied to recommendations from the recommendation engines (S1210). The recommendations are merged and re-sorted (S1211) before sent to user's client terminal.

The method to extract same or similar state instances from state database is omitted because it is same as what illustrated in FIG. 7.

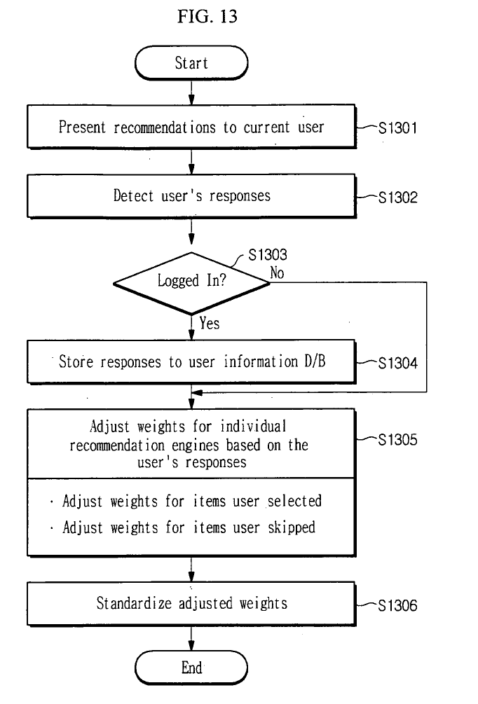

FIG. 13 shows a detail process of updating weights for recommendation engines. As shown in FIG. 13, the system of this invention presents recommendations, using the process described above, to the user who requested the recommendation (S1301). The user then responds by clicking on or opening one or more items in the recommendation list. These responses are sent to the state application module 430 and the state application module detects the user's responses (S1302).

The state application module 430 adjusts the weights for recommendation engines based on the user's responses (S1305). The adjustments can be one of the two kinds—adjustments for the items selected and adjustments for the items skipped. If a user selects an item from the list, this implies that the item is relevant to the user. Therefore, the weights for the recommendation engines that brought the item are increased. On the other hand, if the user skips an item in the list, this implies that the item is not relevant to the user. Thus, the weights for the recommendation engines that brought the item are decreased. Finally, the adjusted weights may need to be normalized such that their values fall between certain ranges 0 and 1 (S1306).

The system, equipments, and methods for this invention have been explained in detail. A step-by-step implementation example will be described below for more detail illustrations of the invention.

### IMPLEMENTATION EXAMPLE

<Detecting User State Variables>

The methods to detect user state variables vary across different variables.

1. “Time of the day” of “Day of the week”: The web server automatically adds time stamp whenever a request arrives. Therefore, time and day information is automatically gathered.

2. “Time spent on a page”: The time difference between requests for a page and the next page can be used as the proxy of the time spent for the first page. If the session ends without request for the next page, the time for the last page cannot be calculated.

3. “Type of site”: If the system of this invention is provided to multiple sites such as Yahoo!, Amazon, etc., the type of site that current user is visiting is also an important state data. Although there are numerous methods to detect the category of a site the current user is visiting, two general methods exist—implicit and explicit method. Explicit method uses clear categories and labels. For example, types of sites can be manually pre-categorized based on the main activities and type of information provided. When a user requests a search or a recommendation from a site, the site type can be identified from the pre-categorization. Implicit method uses similarities among sites. For example, similarity between two sites can be calculated according to the similarities of contents of those sites. When a user requests a search or a recommendation from a site, the content of the site is analyzed and it is assumed that sites with similar contents are of similar types.

4. “Field of service”: The field of service can be inferred from the keywords he/she is using. There exist several methods to infer the field of service from keywords used. An example of those methods is building a keyword ontology. Keyword ontology can be built from a set of important keywords and it is hierarchical—there is a top keyword at the first level, 3-9 sub-keywords at the second level under the top keyword, 3-9 sub-keywords for each second level keyword, and so forth. When a user requests a search with a keyword, the keyword is located in the ontology: If it is found, its second or third level parent keyword is identified by tracing the ontology upward. The second or third level parent keyword is regarded as the “field of service” of current user. Fields having second or third level parent keywords close to each other can be regarded as similar fields.

5. “Location”: If current user is using a mobile device with GPS, the location of current user can be obtained from the device.

6. “Region”: If the location information is not available, the region of current user can be obtained from the IP address or the user information the user provided when registering.

7. “User's current interest”: The user's current interest is also important information. There are explicit and implicit methods to collect user's current interest. Explicit method gathers user's current interest by directly asking to users when they visit a site or request a search or a recommendation. Implicit method infers user's current interests from the documents retrieved. A set of common keywords from the documents current user retrieved are extracted and compared against keywords of past users'. It is very likely that the past users who had similar common keywords had similar interests.

<Searching Similar State Instances from the State Database>

There are several ways to search state instances same as or similar to current user's state. An implementation example is as follows:

1. Compare current user's state data with the values of state instances stored in the database and assign similarity values. For example, suppose the current user is using the system at 1:00 p.m. The similarities of the “time of the day” variable in the database can be calculated by assigning a number to each state instance, which is higher if the time is closer to 1:00 p.m. and lower if the time is farther from 1:00 p.m. A mathematical formula to calculate the number is as <Formula 1>.

$$Similarity = 1 - \frac{\begin{matrix}\vert Current time - “ Time of the day ” \\ in the state instance \vert\end{matrix}}{12} \qquad [ Formula 1 ]$$

The formula assigns 1 if the current time is same as “Time of the day” value in a state instance and 0 if the current time is 12 hours apart from “Time of the day” value in a state instance.

For those state variables that have discrete values such as “Field of service” and “Site type,” 1 is assigned if the value is same and 0 is assigned otherwise. For example, if current user requests a search from an online shopping mall, 1 is assigned to those state instances whose “Site type” is online shopping mall and 0 is assigned to other state instances.

2. Once similarities are calculated, the similarities of each state instance are summed to calculate total similarity index. <Table 1> below shows an example of calculating total similarity indices. Theoretically, the number of state variables and the number of information gathering engines can be infinite, but for the simplicity of illustration, it is assumed that there are 3 state variables and 3 information gathering engines in the example.

TABLE 1

| | | | | Weight for | Weight for | Weight for |
|---|---|---|---|---|---|---|
| | State | State | State | information | information | information |
| | Variable 1 | Variable 2 | Variable 3 | gathering | gathering | gathering |
| | (Time) | (Site type) | (Field of service) | engine 1 | engine 2 | engine 3 |
| State instance 1 | 5:30 am | Shopping mall | Camera | 0.5 | 0.9 | 0.6 |
| State instance 2 | 11:30 am | News | Politics | 0.9 | 0.4 | 0.7 |
| . . . | . . . | . . . | . . . | . . . | . . . | . . . |
| State instance m | 5:30 pm | Portal | Culture | 0.8 | 0.7 | 0.9 |

Suppose the current user is requesting a search or a recommendation about culture from a news site at 5:30 a.m. The similarity indices of state instances in the table can be calculated as follows:

State instance 1=1(Time)+0(Site type)+0(Field of recommendation)=1

State instance 2=0.5(Time)+1(Site type)+0(Field of recommendation)=1.5

State instance m=0(Time)+0(Site type)+1(Field of recommendation)=1

3. The state instances then are sorted according to their similarity indices and the top n instances which are most similar to current user can be taken.

<Merging and Presenting Information>

Two examples of merging information from multiple information gathering engines (search engines or recommendation engines) are as follows:

First, once information lists from multiple information gathering engines are collected, the frequency of each item in those lists is counted. Items in the lists are sorted according to this frequency. If weights for information gathering engines are available, as in this invention, the frequencies can be adjusted by those weights.

Second, most information gathering engines calculate relevancy scores when they generate recommendations. The relevancy scores are standardized such that cross-engine comparison is possible. Then, the items can be sorted by total relevancy score which is calculated by adding relevancy scores for an item from different information gathering engines. Same as in the previous example, the relevancy scores can be adjusted by the weights for information gathering engines.

The maximum length of information list is theoretically infinite. However, information items are usually displayed in the length of 10 or 20, considering human users' cognitive processing capacity. In this invention, recommendations can also be displayed in 10 or 20 items. Optionally, more items are displayed if user requests.

<Adjusting Weights>

In the state database, weights for individual information gathering engines are stored as well as values of state variables. For example, if there are 3 information gathering engines, each state instance has 3 weights, each of which corresponds to an information gathering engine. At the beginning, the weights for information gathering engines are set equal, and they are adjusted as users respond to the information list provided.

After information list is presented to users, their feedback can be collected in several ways. Here, three example methods to collect user feedback are described. First, after information list is presented to a user and he/she clicks on an item, he/she is asked to rate the relevancy of the item. The direct ratings from the user can be used to evaluate relevancy of items. Second, after information list is shown to a user, he/she clicks on items that seem to be relevant to him/her. If the user skips an item, that item probably is not relevant to the user. Therefore, for each item that the user clicked, the weights for the information gathering engines that found the item are increased. On the other hand, for each item that the user skipped, the weights for the information gathering engines that did found the item are decreased. Third, if the data on how much time the user spent on each item are available, the time can be used as an indicator of relevancy. If the user spent long time for an item, it implies that the item was relevant to the user. Therefore, the information gathering engines that found the item gets more weight increases than those items that the user spent short time.

An implementation example of weight adjustment is as follows:

1. When the user clicks on an item in the list: The weights for the information gathering engines that brought the item are increased by the number in Formula 2. For the information gathering engines that did not bring the item, weights are decreased by a small number such as 0.01.

2. When the user skips an item in the list: The weights for the information gathering engines that brought the item are decreased by the number in Formula 2. For the information gathering engines that did not bring the item, weights are increased by a small number such as 0.01.

Weight adjustment=1/(Rank of the item in the list of each information gathering engine) [Formula 2]

For example, if the item was in the second position in the recommendation or search result, the weight adjustment is ½=0.5.

Suppose search results or recommendations were merged and presented to a user as in <Table 2>. Also suppose the initial weights for information gathering engine and the state of the user is same as the first state instance in <Table 1> (searching information about camera at 5:30 a.m).

TABLE 2

| | Original search results or recommendations | | | |
|---|---|---|---|---|
| | Information | Information | Information | |
| | gathering | gathering | gathering | |
| Ranks | engine 1 | engine 2 | engine 3 | Final results |
| 1 | Web Page a | Web Page b | Web Page c | Web Page a |
| 2 | Web Page b | Web Page a | Web Page d | Web Page b |
| . . . | . . . | . . . | . . . | . . . |
| 10 | Web Page x | Web Page y | Web Page z | Web Page x |

Suppose the user skipped Web page a and clicked on Web page b from the final results.

The weights for individual information gathering engines are adjusted as follows:

1. Adjustment for selecting Web page b:

New weight for information gathering engine 1=0.5(current weight)+½=1

New weight for information gathering engine 2=0.9(current weight)+1/1=1.9

New weight for information gathering engine 3=0.6(current weight)−0.01=0.59 (Web page b is not in the list)

2. Adjustment for skipping Web page a:

New weight for information gathering engine 1=1.0(current weight)−1/1=0

New weight for information gathering engine 2=1.9(current weight)−½=1.4

New weight for information gathering engine 3=0.59(current weight)+0.01=0.6 (Web page a is not in the list.)

After adjusting weights for information gathering engines, it is desirable to standardize the weights such that the weights are within certain range (e.g. between 0 and 1). When weights are adjusted using the method described above, they could be below 0 or above 1. These weights can be standardized using simple formulas such as described in Formula 3.

Supposed the weights for three information gathering engines are 0.6, −0.3, and 1.5. They can be standardized as follows:

$$Standardized weight = \frac{Current weight - Minimum weight}{( Maximum weight - Minimum weight )} \\ Weight 1 = ( 0.6 + 0.3 ) / 1.8 = 0.5 \\ Weight 1 = ( - 0.3 + 0.3 ) / 1.8 = 0 \\ Weight 1 = ( 1.5 + 0.3 ) / 1.8 = 1 \qquad [ Formula 3 ]$$

As apparent from the above description, this invention will enable websites to provide more accurate search or recommendations to users by applying different weights based upon each user's state to multiple information gathering engines such as search engines and recommendation engines. The weights for individual information gathering engines can be kept up-to-date and reflect changes in users' preferences and needs because the weights are updated dynamically based on users' response to the information provided.

Although a few embodiments of the present invention have been shown and described, it will be appreciated by those skilled in the art that variations and changes may be made in these embodiments without departing from the principles and spirit of the invention, the scope of which is defined in the appended claims and their equivalents.

1. A system for providing information from multiple information gathering engines such as search engines and recommendation engines, comprising a state application module which applies different weights to individual information gathering engines and updates the different weights based upon users' responses to the information provided by those engines.

2. The system of claim 1, wherein the state application module includes:
a user interface module that receives users' or websites' search or recommendation requests and sends search results or recommendation lists to users;
an information gathering engine interface module that receives search or recommendation requests from the user interface module and forwards the requests to multiple information gathering engines;
a state recognition module that collects users' state information when search or recommendation requests arrive;
a state database that stores weights for individual information gathering engines for past states;
a weight extraction module that retrieves past state instances from the state database, compares the retrieved past state instances with current user's state to identify past states same as or similar to the current user's state, and extracts weights for individual information gathering engines from the past state instances; and
a weight application module that receives search results or recommendations from the information gathering engine interface module, applies weights extracted by the weight extraction module, and re-sorts and merges the recommendations from multiple information gathering engines.

3. The system of claim 2, wherein the state application module further includes a weight update module that retrieves state instances similar to current user's state from the state database and updates weights for individual information gathering engines based upon users' feedback to the information provided.

4. The system of claim 1, wherein the weights for individual information gathering engines are determined by one or more user state variables.

5. The system of claim 4, wherein the user state variables comprise more than one of the following variables—site type, field of service, time of the day, day of the week, weather, location or region, user's current interest, and time spent for a page.

6. The system of claim 1, wherein the information gathering engines are search engines that search information based on the keywords given by the users and the search results from the search engines are weighted by current user's state data.

7. The system of claim 1, wherein the information gathering engines are recommendation engines that provide recommendations for users and the recommendations from the recommendation engines are weighted by current user's state data.

8. The system of claim 7, wherein the state application module further include a user information database that stores users' personal information which is collected when a user logs in to the system.

9. An apparatus for providing information search or recommendation service upon users' requests using multiple search or recommendation engines, comprising:
means that applies weights to the search or recommendation engines based upon current user's state data and past state data stored in a state database; and
means that updates weights for the search or recommendation engines based upon users' feedback on search results or recommendation lists.

10. The apparatus of claim 9, wherein the means that applies weights to the search or recommendation engines includes:
a user interface module that receives users' search or recommendation requests from a web server and sends search or recommendation lists that the weights are applied;
an information gathering engine interface module that receives the search or recommendation requests from the user interface module and forwards the requests to the search or recommendation engines;
a state recognition module that recognizes a user's state variables when the user requests a search or recommendation;
a state database that stores weights for multiple information gathering engines; and
a weight extraction module that compares current user's state data from user interface module with past state instances in the state database to extract past states same as or similar to the current user's state, and
the means that updates weights for the search or recommendation engines includes a weight application module that receives search results or recommendations from the information gathering engine interface module, applies weights from the weight extraction module to the multiple information gathering engines, merges and re-sorts the information lists from the multiple information gathering engines.

11. The apparatus of claim 10, wherein the means that updates weights for the search or recommendation engines further includes a weight update module that retrieves weights from the state database and updates weights based upon users' feedback to the information provided.

12. The apparatus of claim 9, wherein the weights for the search or recommendation engines are determined by one or more user state variables.

13. The apparatus of claim 12, wherein the user state variables comprise more than one of the following variables—time of the day, day of the week, time spent on a page, type of site, field of service, location, region, and user's current interests to apply weights to the search or recommendation engines.

14. A method for providing information search upon users' requests using multiple search engines, the method comprising the steps of:
receiving users' search keywords and forwards the received search keywords to the search engines;
receiving search results from the search engines and recognizing current user's state;
searching for past state instances same as or similar to current user's state from a state database;
extracting weights for the search engines from the past state instances found in the state database and applying the weights to the search engines based on the current user's state data along with the past state data stored in the state database to merge and re-sort the search results; and
updating the weights for the search engines based on users' feedback on the search results.

15. The method of claim 14, further comprising the steps of: after the step of updating the weights for the search engines based on users' feedback on the search results,
sending the re-sorted search results to the user so that the user sees the search results and selects an item from a search result list;
detecting a response of the user who selected the item; and
updating weights for the search engines for a given state based on the detected user responses.

16-17. (canceled)

18. A computer readable medium having a program recorded thereon to cause a computer to process the method of claim 14.

19. A method for providing recommendations upon users' requests using multiple recommendation engines, the method comprising the steps of:
receiving users' requests and user information and forwarding the received users' requests and user information to the recommendation engines;
receiving recommendations from the recommendation engines and recognizing current user's state;
searching for past state instances same as or similar to the current user's state from a state database;
extracting weights for the multiple recommendation engines from the past state instances found in the state database and applying the weights to the recommendation engines based on the current user's state data along with the past state data stored in the state database to merge and re-sort the recommendations; and
updating the weights for the recommendation engines based on users' feedback on the recommendations.

20. The method of claim 19, further comprising the steps of:
sending the re-sorted recommendations to the user so that the user sees the recommendations and selects an item from a recommendation list;
detecting a response of the user who selected the item; and
updating weights for the recommendation engines for a given state based on the detected user responses.

21. The method of claim 19, further comprising the steps of:
logging in a web site having the recommendation engines by a user;
storing user information in a user information database; and
using the user information when the weights for the recommendation engines are applied.

22-23. (canceled)

24. A computer readable medium having a program recorded thereon to cause a computer to process the method of claim 19.
